(19) United States
(12) Patent Application Publication
(10) Pub. No.: US 2005/0036817 A1
(43) Pub. Date: Feb. 17, 2005

(54) Method and apparatus for reducing label length error in a label printer

(76) Inventors: Kevin L. Wilken, Wauwatosa, WI (US); Peter G. Ross, Germantown, WI (US)

Correspondence Address: QUARLES & BRADY LLP, 411 E. WISCONSIN AVENUE, SUITE 2040, MILWAUKEE, WI, 53202-4497, US

(21) Appl. No.: 10/639,360

(22) Filed: Aug. 12, 2003

(51) Int. Cl. B41J 11/42

(52) U.S. Cl. 400/582

(57) ABSTRACT

A printer has a sensor for detecting notches spaced along a label media fed through the printer at a reference distance, where the reference distance is selected as a multiple of a number of steps. As the label media is fed through the printer, the printer monitors the command to and/or feedback from a motor to determine an expected feed length, monitors the notches to determine an actual feed length, and compares the actual feed length to the expected feed length to determine a difference. The printer then adjusts the command to the motor to account for the difference, and therefore to minimize the difference between the actual feed length of the label media and the desired feed length of the label media.

### CROSS REFERENCES TO RELATED APPLICATIONS

Not Applicable

### STATEMENT REGARDING FEDERALLY SPONSORED RESEARCH

Not Applicable

### TECHNICAL FIELD

The present invention relates to a thermal transfer printer, and more particularly to a thermal transfer printer for accurately printing labels of a specific length onto a continuous roll of label media.

### DESCRIPTION OF THE BACKGROUND ART

There are a number of U.S. patents that disclose electronic devices for printing indicia on labels, including both hand held units and tabletop units. Hand held label printers, such as the printers disclosed in U.S. Pat. No. 6,113,293, and tabletop printers, such as disclosed in U.S. Pat. Nos. 6,266,075 and 5,078,523, include the same general combination of elements: a print head, means for feeding label media to be printed past the print head, a microprocessor, a read only memory programmed with appropriate instructions to operate the microprocessor, a random access memory, a keyboard with letter, number, and function keys for the entry of alphanumeric information and instructions concerning the indicia to be printed, and a visual display such as a light emitting diode (LED) or liquid crystal display (LCD) unit to assist the operator in using the machine. In a hand held printer, these components may all be enclosed in a single housing. These printers typically print onto the label using a thermal transfer process which uses a heat generating print head to transfer a pigment, such as wax, carbon black, or the like, from a thermal transfer ribbon to a label media. By using digital technology, characters are formed by energizing a sequence of pixels on the print head which in turn melts the wax or other pigment on the ink ribbon transferring the image to the label media.

In known thermal transfer label printers, label media is fed by a paper feed roller simultaneously with a platen roller feeding an ink transfer ribbon. While the label media driven by the feed roller runs between the print head and the rotating platen roller, the transfer ribbon is passed between the print head and the platen roller by rotating the platen roller. As a result, the label media and the transfer ribbon pass together in overlay relationship between the print head and the platen roller.

To drive the label media, the printer includes a drive mechanism that feeds the ink ribbon and label media past the print head. In hand held printers, these drive mechanisms are typically provided with relatively small, inexpensive motors which are coupled to the roll of label media through a drive mechanism which includes one or more gear and/or drive roll. Such motor drive mechanisms provide an adequate drive system at a reasonable cost. However, these motors are typically difficult to control with a great deal of accuracy and this problem is exacerbated by the tolerances in the gearing and drive rolls employed in the drive mechanism which result in variations in the amount of actual label media dispensed by the drive mechanism. These problems, for example, are particularly acute when the drive system includes a stepper motor, as stepper motors are inherently limited to move in multiples of “steps”.

In printing labels, however, it is important to provide a wide range of label lengths, to be able to repeatably print labels of a selected length, and, furthermore, to be able to align the printing provided by the printer with preprinted text or graphics in the labels. Typical drive mechanisms, as described above, do not provide sufficient control to meet these objectives. These problems are exacerbated by slippage in the label media and wear on the platen in the printer. Moreover, when a series of labels is printed, the length error accumulates, and can result in a significant offset as the printing process continues, often resulting in misprinted and wasted labels. Difficulties in repeatably producing labels are particularly acute when the label is intended to “line up” the printed text with pre-printed or stamped features on the item being labeled, and particularly when labels are relatively long in length.

Due to these problems, it is desirable to control the length of travel of the roll of label media as it moves through the printer with a high degree of accuracy to assure that graphics can be applied to the labels at accurate locations. It is further desirable to minimize errors in the length of label media that is dispensed to provide labels of a repeatable length, and to improve the ability to align preprinted material with graphics provided by the printer.

### SUMMARY OF THE INVENTION

The present invention provides a label printer comprising a print mechanism, a motor responsive to a command for driving a roll of a label media into the print mechanism, and a sensor for sensing length indicators disposed on the roll of label media at a reference interval as it is fed under the print mechanism. A processor is electrically connected to the sensor to receive a signal indicating that a length indicator has been fed through the printer mechanism and connected to the motor to issue commands to the motor. In operation, the processor calculates an expected feed length based on the motor command or feedback, compares this value to the actual feed length as defined by the reference interval, and adjusts the command to the motor based on the difference.

A general objective of the present invention is to provide a label printer with improved label printing accuracy. The printer comprises a shaft for accepting a roll of label media including a plurality of spaced notches along an edge, a stepper motor coupled to the shaft to drive the roll of media, and a print head for receiving label media from the roll and for printing a graphic on the label media. The printer further includes a light emitter and a light detector which are provided on opposing sides of the label media adjacent the edge including the notches. A processing unit is electrically connected to the motor and to the light detector, wherein as the motor drives the label media past the light detector, the light detector provides a signal to the processing unit when a notch passes. During operation, the processor counts the number of steps taken by the motor between notch signals, compares this value to a reference number of steps between notch signals, and calculates an error value. The processor adjusts the step command to the motor based on the calculated error value.

Another objective of the present invention is to provide a method for determining the feed length of a continuous roll of material fed through a printer. The method comprises the steps of providing a plurality of substantially equally spaced indicators spaced at a reference distance along the length of the roll of material providing an indication of an actual feed length, sensing a position of each indicator as the indicator is fed through the printer, calculating the expected feed length between indicators based on at least one of a command to and a feedback parameter from the motor, and comparing the expected feed length to the actual feed length to determine a distance. Based on the result of the comparison, the command to the motor is adjusted to minimize the difference between the actual and the expected feed length.

Yet another objective of the invention is to provide a label media for use with a hand held label printer. The label media comprises an elongated portion of a labeling material which has both a width and a length. A plurality of notches are formed along the length of the labeling material, and are spaced to provide indicators for measuring the length of the media.

The foregoing and other objectives and advantages of the invention will appear from the following description. In the description, reference is made to the accompanying drawings which form a part hereof, and in which there is shown by way of illustration a preferred embodiment of the invention. Such embodiment does not necessarily represent the full scope of the invention, however, and reference is made therefore to the claims herein for interpreting the scope of the invention.

### BRIEF DESCRIPTION OF THE DRAWINGS

FIG. 1 is a block diagram of a hand held label printer which employs the present invention;

FIG. 2 is a perspective view of a label media for use with the printer of FIG. 1;

FIG. 3 is a flow chart illustrating process steps for controlling the length of a label in the printer of FIG. 1;

FIG. 3a is a flow chart illustrating the process steps of FIG. 3 for a preferred embodiment of the invention;

FIG. 4 is a perspective view of a hand held label printer which employs the present invention;

FIG. 5 is a perspective view of the printer of FIG. 4 with the top portion, keyboard, display, and top portion of the cartridge removed;

FIG. 6 is a perspective view of the printer of FIG. 4 with the cartridge top portion, keyboard, and display removed;

FIG. 7 is a perspective view of the cartridge insert shown in FIG. 6;

FIG. 8 is a bottom view of a cartridge of label media of FIG. 4 with the top, bottom, and periphery wall removed;

FIG. 9 is a detailed bottom perspective view of the cartridge receptacle of FIG. 7; and

FIG. 10 is a bottom perspective view of the gear assembly of the printer of FIG. 4.

### DETAILED DESCRIPTION OF THE PREFERRED EMBODIMENTS

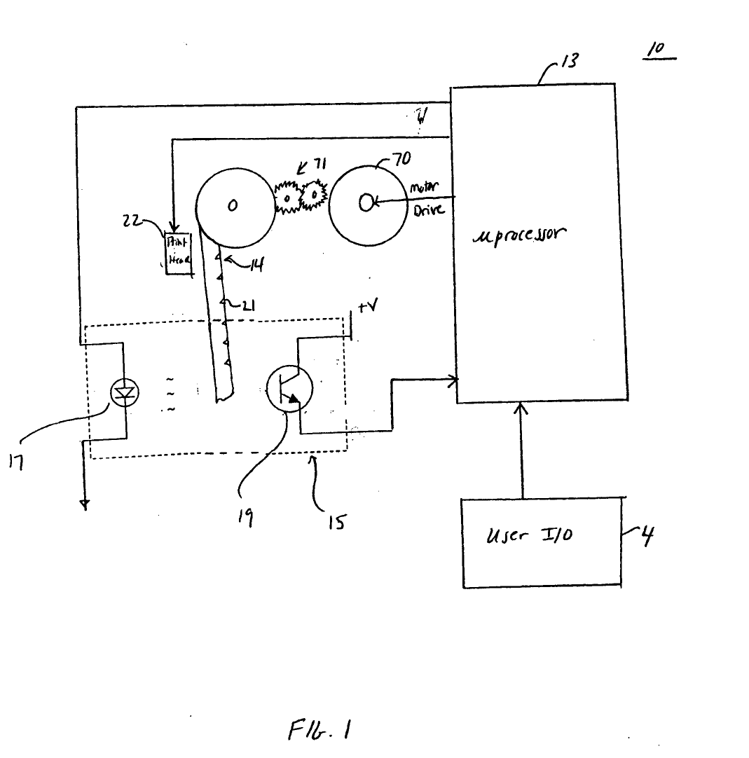

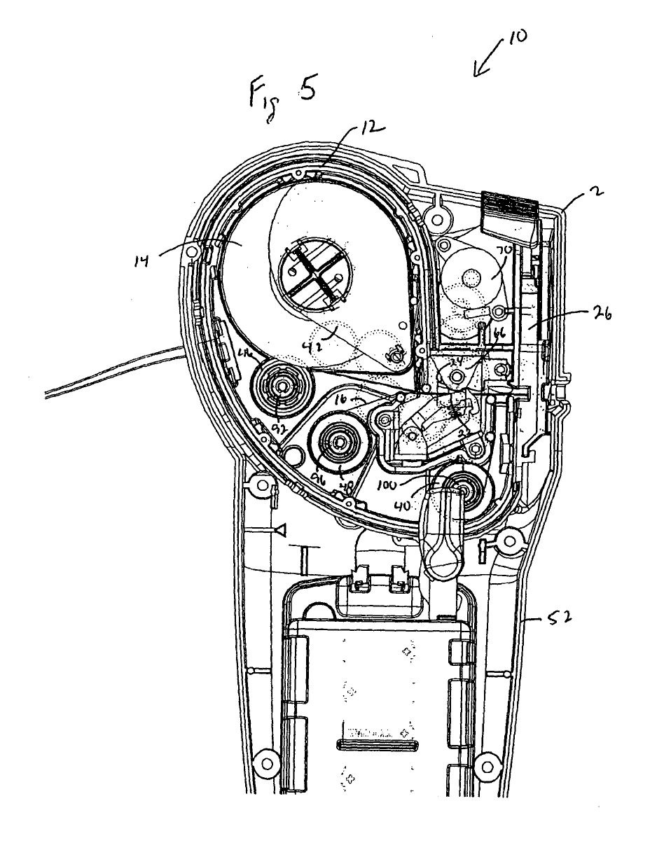

Referring now to the Figures, and more particularly to FIG. 1, a simplified block diagram of a hand held thermal printer 10 constructed in accordance with the present invention is shown. The printer 10 comprises a processor 13 which receives input data from a user input device such as a keyboard 4, and commands a print head 22 to print a graphic selected by the user, such as a picture or text message, onto a roll of label media 14. To print a label, the processor 13 drives a motor 70 which, through a drive mechanism 71 comprising a series of gears, as described below, advances a roll of label media 14 and an ink ribbon 16 (FIG. 5) under the print head 22. After a label is printed, the printer 10 drives the printed label out of the printer 10, and provides clean label media 14 and ink ribbon 16 for printing another label.

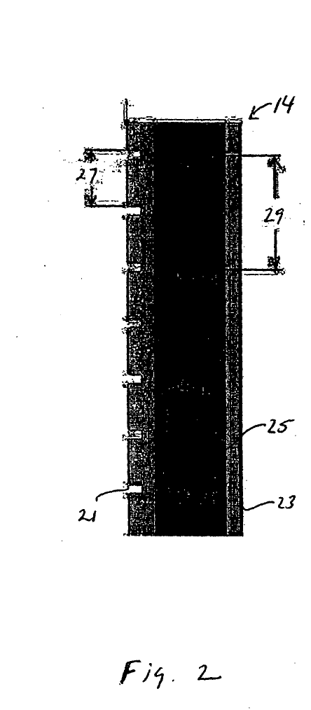

Referring still to FIG. 1 and also to FIG. 2, the label media 14 can be any of a number of types of labeling material known in the art, but the labeling material typically comprises a carrier web 23 to which a plurality of successive adhesive labels 25 are attached at selected print intervals 29. The carrier web 23 includes a plurality of notches 21, cut successively at a selected reference distance 27 along an edge on at least one side of the label media 14. The reference distance 27 provides a measure for determining an actual feed length at label media 14 through the printer. The reference distance 27 can be, for example, selected to be equivalent to a number of “steps” taken by a stepper motor, and to provide a reference number of steps for determining an amount of error in the feed length of the label media 14, as described below.

In operation, the label media 14 is fed through a sensor 15 which includes a source 17 and associated detector 19, which can be, as shown, a light emitting diode (LED) and a phototransistor, respectively. The source 17 and detector 19 are provided on opposing sides of the label media 14 such that, as the notches 21 pass through the sensor 15, light from the source 17 passes to the detector 19, activating the detector 19, and providing a “notch” signal to the processor 13. When a notch 21 is not present, the carrier web 23 prevents light emitted from the source 17 from reaching the detector 19, and no signal is provided to the processor 13.

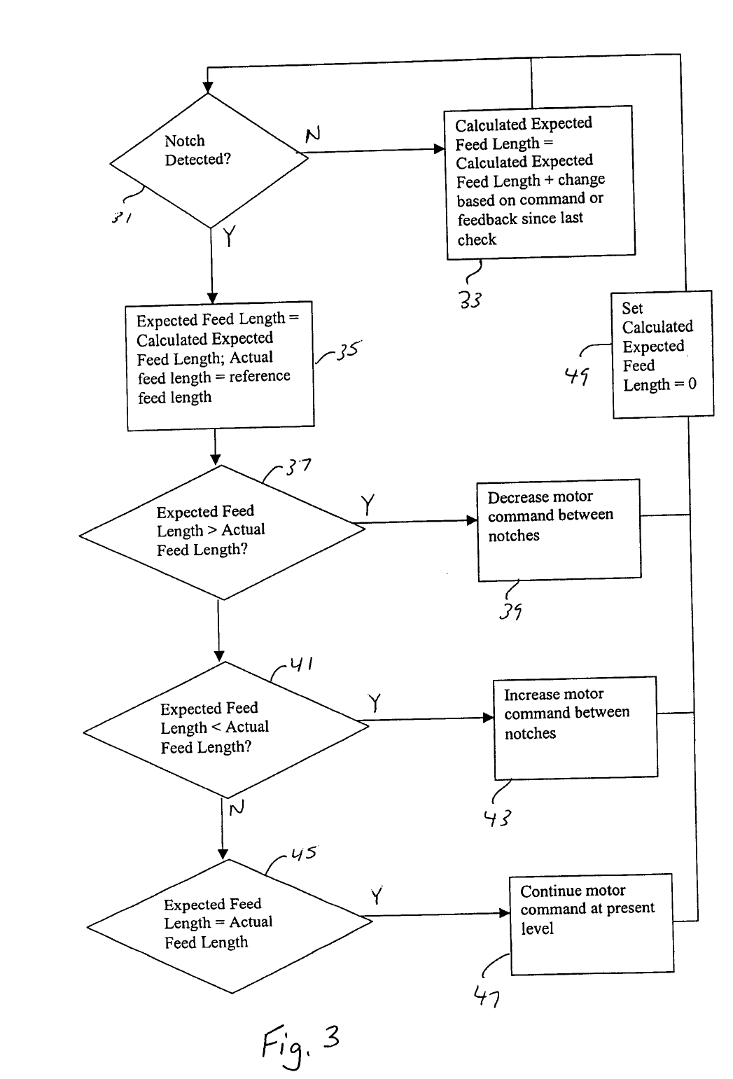

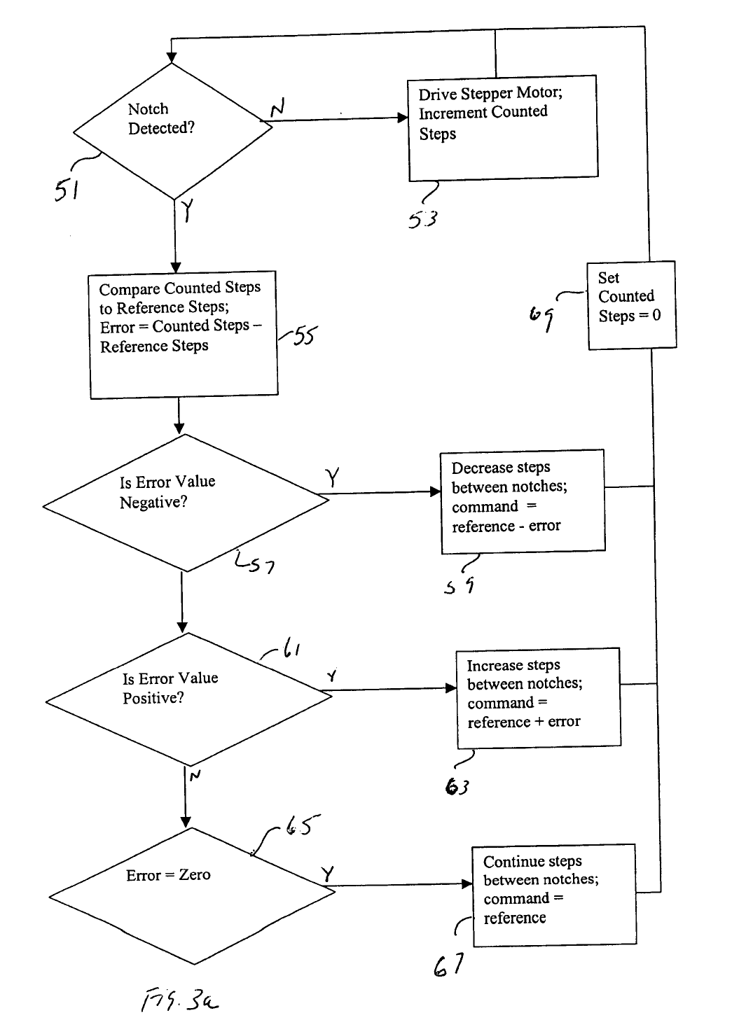

Referring now also to FIG. 3, a flow chart is shown illustrating control of the motor 70 by the processor 13 to feed the label media 14. In this process, the processor 13 compares the “expected feed length”, or the amount of label media 14 that is expected to be fed by the printer based on the command to or feedback from the motor 70, to the “actual feed length”, or the measured length of media between notches and determines a difference between the actual and expected feed lengths, as described below. The motor 70 can be, for example, a DC, AC, servo, stepper, or other type motor. The expected feed length can be calculated based on, for example, time intervals of feed at a selected speed, feedback such as a frequency count from an encoder, or using other feedback or command monitoring techniques which will be known to those of skill in the art. The command and/or feedback values monitored between notches 21 are used to calculate an expected feed length between notches 21.

As the label media 14 is fed through the printer 10, the processor 13 monitors the sensor 15 for notch signals indicating that a notch 21 has been detected (step 31). The notch signal indicates that a predetermined length of label media (an actual feed length), as defined by the reference distance 27 between the notches 21, has passed. If no notch signal is detected, the processor 13 continues to drive the motor 70, and continually calculates the expected feed length, incrementing the calculated feed length value based on the command to the motor and/or feedback during each iteration of the loop (step 33). If a notch 21 is detected, the processor 13 sets the expected feed length between notches equal to the calculated feed length and sets the actual feed length equal to the reference distance 27 (step 35). The processor 13 then compares the expected feed length to the actual feed length. If the expected feed length is greater than the actual feed length (step 37), the processor 13 adjusts the command to the motor 70 to decrease the feed between notches (step 39). If the expected feed length is instead less than the actual feed length (step 41), the processor 13 adjusts the command to the motor 70 to increase the feed between notches (step 43). Finally, if the expected feed length is substantially equivalent to the actual feed length (step 43), the processor 13 continues to drive the motor 70 at the same command, (step 47). After a notch is detected, the expected feed length calculator is reset to zero (step 49) to begin calculating the expected feed from the next interval between notches.

Referring now also to FIG. 3a, a flow chart of a preferred embodiment of the invention is shown illustrating control of a motor 70 by the processor 13 to feed the label media 14 when the motor 70 is a stepper motor. The motor 70 will, hereafter, be described as a stepper motor 70, with reference to this embodiment and to the figures of the preferred embodiment below. Here, as the label media 14 is fed through the printer 10, the processor 13 monitors the sensor 15 for notch signals indicating that a notch 21 has been detected (step 51). The notch signal indicates that a predetermined length of label media, as defined by the reference distance 27 between the notches 21, has passed. The reference distance 27 is selected to be equivalent to a multiple of steps taken by the motor 70, and provides a reference number of steps (Reference Steps) for comparison purposes. If no notch signal is detected, the processor 13 continues to drive the stepper motor 70, and increments a counter counting the number of steps taken by the stepper motor 70 (Counted Steps) between notch signals (step 53). If a notch 21 is detected, the processor 13 compares the counted number of steps to the reference number of steps between notches, and calculates an error equal to the difference between the counted number of steps and the reference number of steps (step 55). If the error is negative (step 57), the processor 13 adjusts the command to the stepper motor 70 to decrease the number of steps taken between notches (step 59), such that the command is equal to the reference number of steps minus the error. If the error is instead positive (step 61), the processor 13 adjusts the command to the stepper motor 70 to increase the number of steps taken between notches (step 63), such that the command to the stepper motor 70 is equal to the reference number of steps plus the error. Finally, if the error is zero, (step 65), the processor 13 continues to drive the stepper motor 70 at the same command, (step 67), e.g. at the reference number of steps for a given time frame. The processor 13 then sets the counted number of steps back to zero (step 69) to count up to the next notch signal.

Therefore, as the processor 13 drives the stepper motor 70, it continually monitors the notches 21 and varies the number of steps taken by the stepper motor 70 to maintain the feed of label media 14 approximately equivalent to a desired feed length for printing a selected label. The error in length for each label printed is therefore minimized, and repeatability of label length is improved.

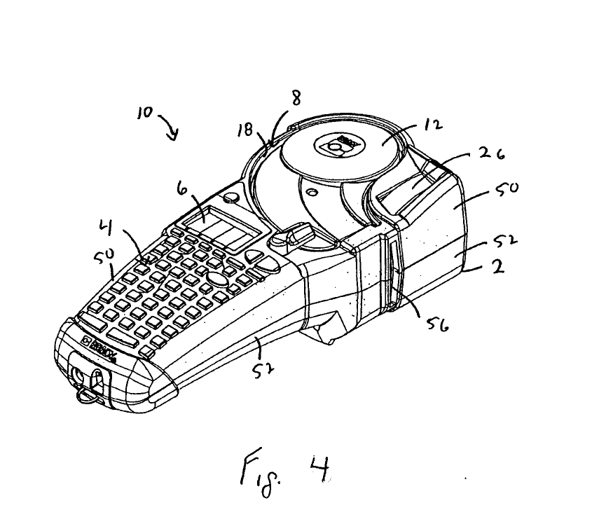

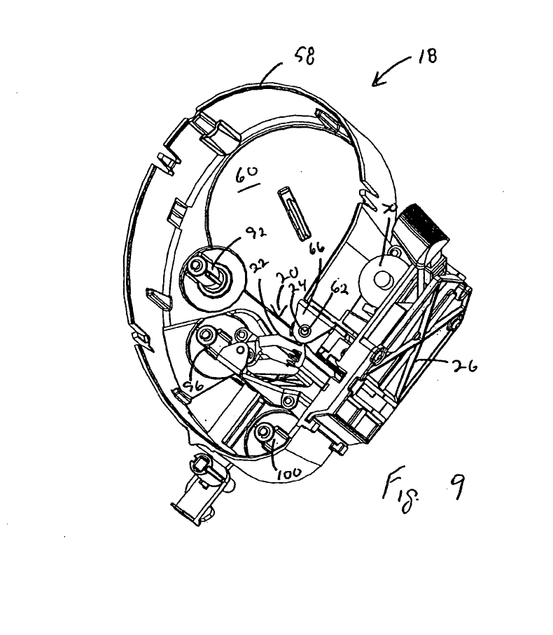

Referring now to FIGS. 4 and 5, a hand held thermal printer 10 employing a preferred embodiment of the present invention is shown. The thermal printer 10 includes a molded plastic housing 2 that supports the keyboard 4 on its front surface and a display 6 positioned above the keyboard 4. An opening 8 formed in the housing 2 above the display 6 receives a cartridge 12 containing the roll of label media 14 and an ink ribbon 16. The cartridge 12 is inserted through the opening 8 into a cartridge receptacle 18 housed in the printer housing 2, and the label media 14 and ink ribbon 16 from the cartridge 12 are threaded through a printer mechanism assembly 20 (FIG. 9) and urged along a web path through a print head 22 and platen roller 24 for printing indicia on labels forming part of the label media 14. The printed labels pass through a cutter mechanism 26 which cuts the label media 14 to separate the printed labels from unprinted labels.

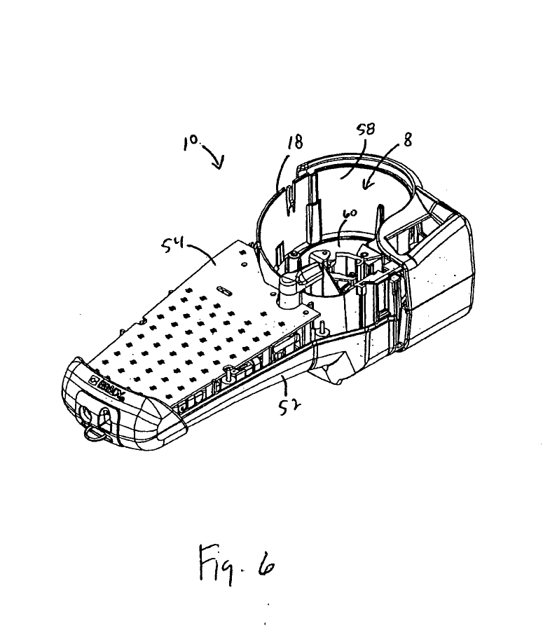

Referring now also to FIG. 6, the cartridge 12 is received in the cartridge receptacle 18 housed in the printer housing 2. The printer housing 2 is, preferably, formed from at least two portions 50, 52, and houses printer components, such as the cartridge receptacle 18, the keyboard 4, display 6, the cutter mechanism 26, a printed circuit board 54 having printer circuitry, and including the processor 13 described above. The opening 8 formed in the housing top portion 50 provides access to the cartridge receptacle 18 for insertion of the cartridge 12 into the cartridge receptacle 18. A slot 56 formed in the housing 2 adjacent the cutter mechanism 26 provides an exit for label media 14 (FIG. 5) which has passed through the cutter mechanism 26.

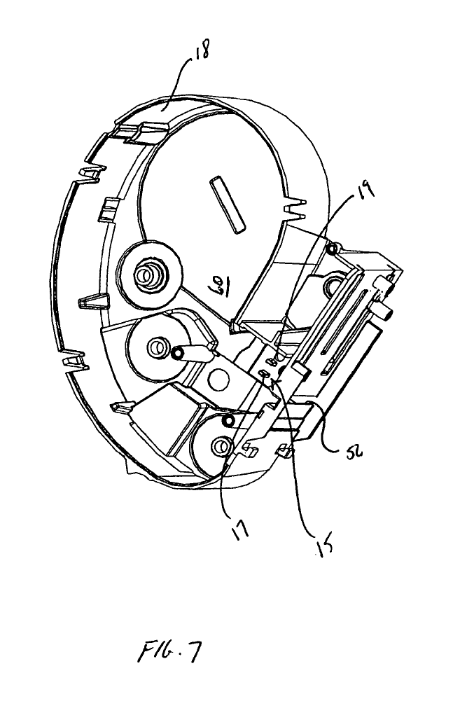

Referring now to FIGS. 5 and 7, the sensor 15 is coupled to a bottom wall 60 of the cartridge receptacle 18 positioned adjacent the slot 56, such that label media 14 routed through the printer (FIG. 5), passes the sensor 15 as it approaches the cutter mechanism 26 and slot 56. The source 17, is provided parallel to and directed at the detector 19 and is spaced a distance apart from the detector 19 to allow sufficient space for the label media 14 to move between the source 17 and the detector 19.

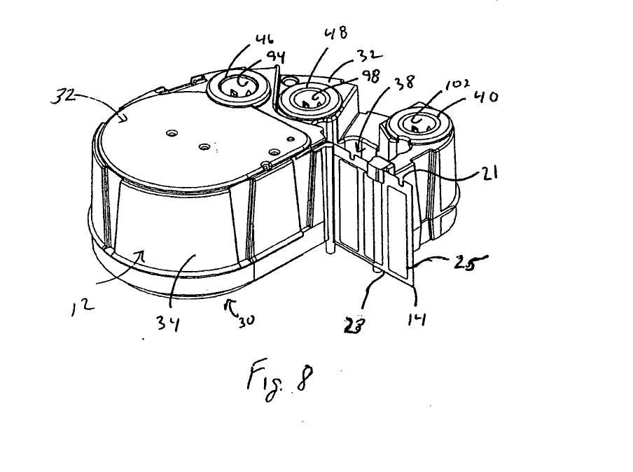

Referring still to FIG. 5 and also to FIG. 8, the cartridge 12 includes a cartridge housing 28 having a top wall 30 and a bottom wall 32 joined by a periphery wall 34. The periphery wall 34 defines a media and ink ribbon container for housing the label media 14 and ink ribbon 16 on spools. The label media 14 and ink ribbon 16 from the cartridge housing 28 pass out of the cartridge housing 28 and through a printing area 38 external to the cartridge housing 28 for engagement with the platen roller 24 and print head 22. The used ink ribbon 16 reenters the cartridge housing 28, and is wound onto an ink ribbon take up spool 40 rotatably mounted in the cartridge housing 28.

Referring still to FIGS. 5 and 8, the label media 14 is housed in the cartridge housing 28 in the form of a roll rotatably mounted on a yoke 42. The yoke 42 is pivotally mounted between the top and bottom walls 30, 32 of the cartridge housing 28, and is pivotally biased by a spring (not shown) toward a label media drive roller 46 rotatably mounted between the top and bottom walls 30, 32 of the cartridge housing 28. Advantageously, the spring biases the roll of label media 14 against the label media drive roller 46 to maintain the label media drive roller 46 in contact with the roll of label media 14 as the diameter of the roll of label media 14 decreases during use.

An ink ribbon supply spool 48 rotatably supported between the top and bottom walls 30, 32 of the cartridge housing 28 has a roll of ink ribbon 16 wound thereon. The ink ribbon 16 unwinds from the ink ribbon supply spool 48 and passes out of the cartridge 12 with the label media 14 through the printing area 38 between the print head 22 and platen roller 24 (FIG. 5). The print head 22 engages the ink ribbon 16 to transfer ink on the ink ribbon 16 onto the label media 14. Once the ink has been transferred, the ink ribbon 16 reenters the cartridge 12, and is wound onto the ink ribbon take up spool 40 supported between the top and bottom walls 30, 32. The cartridge housing 28 frictionally engages both the ink ribbon supply and take up spools 48, 40 to induce a drag, or torque level, on the rotating ink ribbon supply and take up spools 48, 40 in order to maintain tension in the ink ribbon 16. The drag can be adjusted to a desired level using methods known in the art, such as washers, springs, and the like, without departing from the scope of the invention.

Referring now to FIG. 9, the cartridge receptacle 18 has a periphery wall 58 generally shaped to conform with the cartridge periphery wall 34 (FIG. 8), and a bottom wall 60 that supports the cartridge 12 therein. The cartridge receptacle periphery wall 58 surrounds the printer mechanism assembly 20 which is fixed in the printer housing 2 (FIG. 5) relative to the cartridge receptacle 18.

The printer mechanism assembly 20 includes the pivotable print head 22 and stationary platen roller 24. Referring now also to FIG. 5, the print head 22 cooperates with the ink ribbon 16 and the label media 14 such that the print head 22 can print characters or symbols on the label media 14. This is described in greater detail in U.S. Pat. No. 5,078,523 which is incorporated herein by reference.

The label media 14 and ink ribbon 16 passing through the printing area 38 (FIG. 8) are advanced past the print head 22 by the platen roller 24 which maintains the ink ribbon 16 and label media 14 in close cooperation with the print head 22. The platen roller 24 is mounted on a platen roller drive shaft 62 which is rotatably mounted in the cartridge receptacle 18 by a bracket 66. The print head 22 is pivotally mounted relative to the platen roller 24 in the cartridge receptacle 18 to provide space between the print head 22 and platen roller 24 when threading the label media 14 and ink ribbon 16 therebetween.

Referring now again also to FIG. 5, the platen roller 24, label media drive roller 46, ink ribbon supply spool 48, and ink ribbon take up spool 40 are all rotatably driven by a dual feed direction drive mechanism 71 including a single stepper motor 70 that can rotatably drive the rollers 24, 46 and spools 40, 48 in a forward feed direction and a reverse feed direction. In the forward feed direction, the label media 14 passes out of the cartridge 12 and the ink ribbon 16 is unwound from the ink ribbon supply spool 48 and wound onto the ink ribbon take up spool 40. In the reverse feed direction, the label media 14 is urged back into the cartridge 12 and the ink ribbon 16 is unwound from the ink ribbon take up spool 40 and wound onto the ink ribbon supply spool 48. Advantageously, the drive mechanism includes a gear assembly that selectively, simultaneously drives the rollers 24, 46 and spools 40, 48 to synchronize the operation of the platen roller 24, label media drive spool, ink ribbon supply spool 48, and ink ribbon take up spool 40 to smoothly urge the ink ribbon 16 and label media 14 in the forward and reverse feed directions. As described above, the stepper motor 70 is a stepper motor which is commanded by the processor 13 (FIG. 1) on the printed circuit board 54 (FIG. 6) to drive a selected number of steps based on the print interval 29 of the printing process.

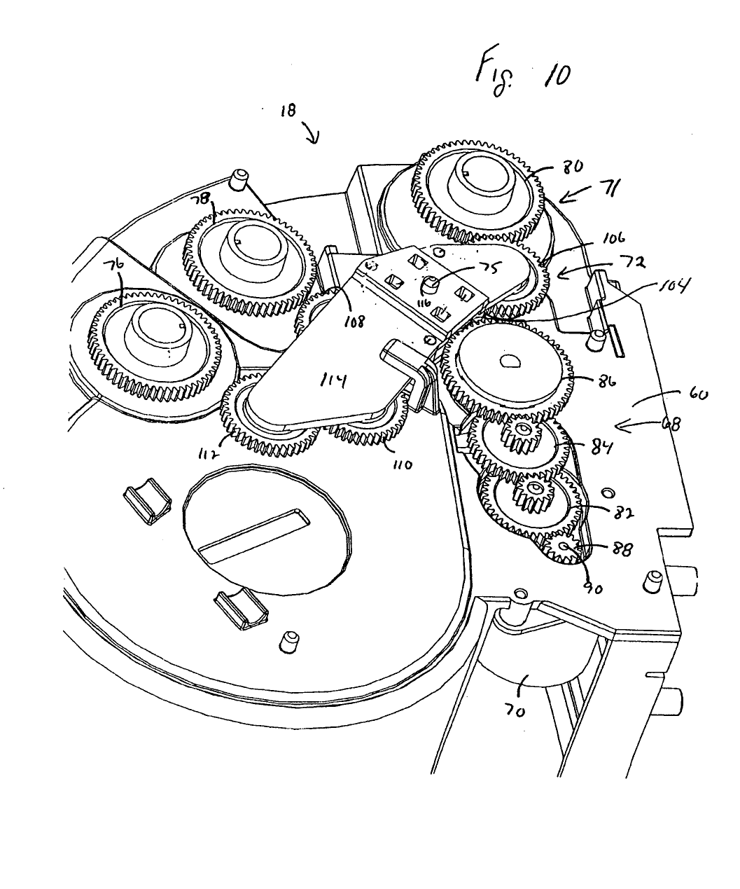

Referring now to FIG. 10, and as described more fully in co-pending application entitled “Printer with Pivoting Gear Mechanism” assigned to the assignee of the present invention and filed on even date herewith as attorney docket number 180825.00002, the drive mechanism 71 includes a gear assembly with a stationary drive gear assembly 68 and a pivotal drive gear assembly 72 that drive the label media 14 and ink ribbon 16 (FIG. 5) in the forward and reverse feed directions using the stepper motor 70. The stationary drive gear assembly 68 includes a label media drive gear 76, ink ribbon unwind drive gear 78, ink ribbon rewind drive gear 80, first and second intermeshed gears 82, 84, and a platen roller drive gear 86. The first and second intermeshed gears 82, 84 transmit power from a pinion 88 to the platen roller drive gear 86 engaging the pivotal drive gear assembly 72. The gears 76, 78, 80, 82, 84, 86 forming part of the stationary drive gear assembly 68 are rotatably mounted to the underside of the receptacle bottom wall 60.

The pivotal drive gear assembly 72 is pivotally mounted on a pivot shaft 75 extending from the underside of the receptacle bottom wall 60 relative to the stationary drive gear assembly 68. The pivot shaft 75 rotatably supports a pivoting gear 104 and a gear plate 114. The gear plate 114 rotatably mounts transition gears 106, 108, 110, 112 that selectively engage the drive gears 76, 78, 80 forming part of the stationary drive gear assembly 68. The pivoting gear 104 is rotatably driven by the platen roller drive gear 86 which pivots the gear plate 114 about a pivot point 116 that is coaxial with the axis of rotation of the pivoting gear 104.

The gear plate 114 pivots about the pivot point 116 between a forward feed position and a reverse feed position to selectively engage one of the transition gears 106, 108, 110, 112 with one of the label media drive gear 76, ink ribbon unwind drive gear 78, or ink ribbon rewind drive gear 80. Although pivoting the gear plate 114 about a pivot point 116 coaxial with the axis of rotation of the pivoting gear 104 is preferred, the gear plate 114 can pivot about any pivot point to selectively engage the transition gears 106, 108, 110, 112 with other gears, such as the label media drive gear 76, ink ribbon unwind drive gear 78, ink ribbon rewind drive gear 80, and the first and second intermeshed gears 82, 84, without departing from the scope of the invention. Moreover, although a plurality of transition gears is preferred for driving the ink ribbon in the forward and reverse feed directions, a single transition gear can be provided to engage the ink ribbon unwind gear in the reverse feed position and the ink ribbon rewind gear in the forward feed position without departing from the scope of the invention.

Referring again to FIGS. 1-10, in use, the cartridge 12 is inserted into the cartridge receptacle 18 with the label media drive shaft 92 received in the label media drive roller 46, the ink ribbon unwind drive shaft 96 received in the ink ribbon supply spool 48, and the ink ribbon rewind drive shaft 100 received in the ink ribbon take up spool 40 to properly position the cartridge 12 in the cartridge receptacle 18 and thread the label media 14 and ink ribbon 16 between the platen roller 24 and print head 22. As inserted, the edge of the label media 14 including the notches 21 is directed downward toward the bottom wall 60 of the cartridge receptacle 18 such that, as the label media 14 is unrolled, the edge of the label media 14 including notches 21 moves through the sensor 15. When properly inserted, the print head 22 is then urged toward the platen roller 24 to sandwich the label media 14 and ink ribbon 16 therebetween.

Once the cartridge 12 is locked in place, the printer 10 is ready to produce printed labels. When printing on the labels, the label media 14 and ink ribbon 16 are fed past the platen roller 24 and print head 22 in the forward feed direction by energizing the stepper motor 70 to rotate in a first direction of rotation which causes the platen roller drive gear 86 to rotate in a clockwise direction. Rotation of the platen roller drive gear 86 in the clockwise direction causes the pivoting gear 104 to rotate in the counter clockwise direction and pivot the gear plate 114 in the counter clockwise direction until the first transition gear 106 engages the ink ribbon rewind drive gear 80, at which point the gear plate 114 ceases to pivot and the first transition gear 106 rotatably drives the ink ribbon rewind drive gear 80, and thus the ink ribbon rewind drive shaft 100, to wind ink ribbon 16 onto the ink ribbon take up spool 40.

As the ink ribbon take up spool 40 is rotatably driven to wind ink ribbon 16 thereon, the platen roller drive gear 86 rotatably drives the platen roller 24 to urge the label media 14 and ink ribbon 16 past the print head 22. When a desired character is input by an operator through the keyboard 4 or other means, the printer circuitry of the printer 10 energizes pixels on the print head 22 as the label media 14 and ink ribbon 16 advance past the print head 22. The head pixels are variously energized to imprint the character on the label media 14. This is described in greater detail in U.S. Pat. No. 5,078,523 which has been incorporated herein by reference.

When a label has been printed, the stepper motor 70 continues to drive the label media 14 and ink ribbon 16 in the forward feed direction to advance the label for removal by the user, such as by cutting the label media 14 using the cutter mechanism 26. As the label media 14 is fed through the printer 10 toward the slot 56, the processor 13 on the printed circuit board 54 monitors output of the sensor 15 for notches 21, counts the number of steps taken between notches, and calculates an “error” difference between the number of steps taken by the stepper motor 70 and the reference number of steps between notches 21 as defined by the reference distance 27. If the error is not zero, such that the counted number of steps varies from number of steps between notches, the processor 13 adjusts the command to the stepper motor 70 accordingly, as described with reference to FIG. 3 above, thereby minimizing the error in label length.

Once the portion of the label media 14 containing the printed label is removed, the remaining label media 14 and ink ribbon 16 can be fed in the reverse feed direction to position the next available label in position for printing without wasting the label media 14 and ink ribbon 16.

While there has been shown and described what is at present considered the preferred embodiment of the invention, it will be obvious to those skilled in the art that various changes and modifications can be made therein without departing from the scope of the invention defined by the appended claims.

1. A method for maintaining a constant feed for a continuous roll of material fed lengthwise through a printer, the method comprising the following steps:
providing a plurality of substantially equally spaced indicators spaced at a reference interval along the length of the roll of material;
sensing a position of each indicator as the indicator is fed through the printer to determine an actual feed length;
determining an expected feed length of the roll of material based on at least one of a command to the motor and a feedback parameter calculated between a first and a subsequent position;
comparing the expected feed length to the actual feed length between indicators;
calculating a difference between the expected and the actual feed length; and
adjusting the command to the motor based on the difference to minimize an error in feed length.

2. The method as defined in claim 1, wherein the step of providing a plurality of equally spaced indicators comprises cutting notches in an edge of the roll.

3. The method as defined in claim 1, wherein the step of sensing the position of the indicator comprises emitting a light at a first side of the roll of material and detecting the light on an opposing side of the roll of material.

4. The method as defined in claim 1, wherein the motor is a stepper motor, the reference interval is equal to a selected number of steps, and the difference is calculated as a number of steps.

5. The method as defined in claim 4, wherein the step of adjusting the command to the motor comprises adjusting the command to the motor by adding the error to the reference interval.

6. A label printer comprising:
a print mechanism;
a motor responsive to a command for driving a roll of a label media into the print mechanism;
a sensor for sensing length indicators disposed on the roll of label media at a reference interval as it is fed under the print mechanism;
a processor electrically connected to the sensor to receive a signal indicating that a length indicator has been fed through the printer mechanism and connected to the motor to issue commands thereto;
wherein the processor determines an expected feed length of the label media by the motor based on at least one of the commands to the motor and a feedback parameter from the motor, determines a known feed length based on the sensed length indicators, calculates a difference between the expected feed length and the known feed length, and adjusts the command to the motor based on the difference.

7. The label printer as defined in claim 6, wherein the sensor comprises a light source and a light detector.

8. The label printer as defined in claim 6, wherein the roll length indicators are notches cut into a side edge of the roll at selected intervals.

9. The label printer as defined in claim 8, wherein the sensor senses a position of a notch.

10. The label printer as defined in claim 9, wherein the motor is a stepper motor and the notches are disposed on the label media at a reference number of steps apart.

11. The label printer as defined in claim 10, wherein the notches are disposed on the label media along a length of the label media.

12. The label printer as defined in claim 7, wherein the motor is a stepper motor and the processor calculates the expected feed length by counting the number of steps taken by the motor.

13. A label printer comprising:
a shaft for accepting a roll of label media, the roll of label media including a plurality of spaced notches along an edge;
a stepper motor responsive to a step command and coupled to the shaft to drive the shaft;
a printing mechanism for receiving the roll of label media and for printing a graphic on the label media;
a light source and a light detector, the emitter and detector being provided on opposing sides of the roll of label media adjacent the edge including the notches such that the detector provides a notch signal when a notch passes; and
a processing unit electrically connected to the motor to provide the step command and to the light detector to receive the notch signal, wherein the processing unit counts the number of steps taken by the stepper motor between notch signals, compares the counted number of steps to a reference number of steps between notch signals to determine an error, and adjusts the step command to the motor based on the calculated error.

14. The label printer as defined in claim 13, wherein the processing unit resets a count of the steps taken by the motor to zero when the notch signal is received.

15. The label printer as defined in claim 13, wherein the print head is a thermal print head.

16. The label printer as defined in claim 13, further comprising a keyboard coupled to the processing unit, the keyboard providing a graphic to be printed onto the label media.

17. The label printer as defined in claim 13, wherein the notches are provided in a side edge of the roll of label media.

18. The label media as defined in claim 13, wherein the roll of label media comprises a carrier web to which a plurality of adhesive labels are affixed.

19. A label media for use with a hand held thermal printer, the label media comprising:
an elongated portion of a labeling material, the elongated portion having a width and a length; and
a plurality of notches formed along the length of the labeling material;
wherein the notches are spaced along the length of the labeling material to provide a reference distance of feed length of the label media.

20. The label media as defined in claim 19, wherein the notches are formed along an edge of the labeling material.

21. The label media as defined in claim 19, wherein the notches are formed along a side edge of the labeling material.

22. The label media as defined in claim 19, wherein the notches are spaced substantially equally along a side edge of the labeling material.

23. The label media as defined in claim 19, wherein the labeling material comprises a carrier web to which a plurality of adhesive labels are affixed.

24. The label media as defined in claim 23, wherein the notches are provided in the carrier web.

25. The label media as defined in claim 19, wherein the notches are spaced at a reference distance selected to be equal to a known number of steps taken by a stepper motor.
